(19) United States
(12) Patent Application Publication
(10) Pub. No.: US 2007/0272056 A1
(43) Pub. Date: Nov. 29, 2007

(54) Method for the Agglomeration of Used Material or Fines from the Production of Organohalosilanes

(75) Inventor: Gerard Simon, Lyon (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, Boulogne (FR)

(21) Appl. No.: 10/557,848

(22) PCT Filed: Apr. 30, 2004
(86) PCT No.: PCT/FR04/01048

§ 371 Date: Apr. 30, 2007

(30) Foreign Application Priority Data
May 21, 2003 (FR) 03/06099

(51) Int. Cl. C22B 1/244; C07F 7/16

(52) U.S. Cl. 75/313; 75/772

(57) ABSTRACT

Process for agglomerating the pulverulent used material and/or the pulverulent fines resulting from the production of organohalosilanes, comprising the mixing of this used material and/or fines with a binder chosen from polysaccharides, in particular starches and dextrins, the addition to this mixture of an amount of water ranging from 3 to 10%, preferably from 4 to 8%, by weight, with respect to the used material+binder combination, the stirring of the solid mixture obtained in the preceding stage, in order to obtain a homogeneous mixture, and the production of a solid agglomerated product by compression in a press. Agglomerated product obtained.

The present invention relates to an agglomeration process which makes possible the deactivation and the recovery of pulverulent used materials and/or pulverulent residual fines resulting from the production of organohalosilanes, and more particularly from the production of methylchlorosilanes, by direct synthesis. The invention also relates to the products resulting from this agglomeration process and to the use of these products for the recovery, in particular, of the residual silicon metal and of metals such as copper.

The industrial use of the process for the direct synthesis of methylchlorosilanes according to the Rochow reaction (reaction of silicon metal with gaseous methyl chloride in the presence of copper-based catalyst) is generally carried out in a fluidized bed. The process requires bleeding or regular emptying of the fluidized bed, resulting in what it is convenient to refer to as used materials and residual fines from the synthesis. These used materials and/or residual fines are pulverulent and comprise, in addition to the silicon metal, possibly silicon oxides and elements such as chlorine, hydrogen or oxygen as well as elements such as copper, carbon, iron, aluminum, zinc, calcium, tin, manganese, and the like. These pulverulent used materials and these pulverulent fines have a highly reactive nature which makes it very difficult, indeed even impossible, to handle them and to transport them as they are. In particular, they react with water in the liquid or vapor form with evolution of hydrogen and exhibit a self-heating nature on contact with the air. The used materials have, for this reason, to be subjected to a deactivation treatment.

Furthermore, the used materials and the fines comprise high proportions of constituents, such as silicon and copper, which it would be advantageous to be able to recover.

Patent U.S. Pat. No. 5,342,430 discloses a deactivation process in which the used material is reacted with an aqueous medium comprising water and a surfactant, optionally at elevated temperature, and then a binder, such as a lignosulfonate, montmorillonite or bentonite, is introduced, it being possible for this treatment to be followed by removal of water.

EP-A-0 287 934 discloses a two-stage process comprising first the agglomeration of the used material (formation of pellets) and then the impregnation of this agglomerate with an organic binder. The organic binder is applied so as to impregnate the agglomerate during the agglomeration or after the latter. The binder can be a liquid organic binder having a viscosity which is sufficiently low to ensure its penetration into the agglomerate or else it can be applied in solution or in aqueous emulsion. The organic binder is presented as penetrating the agglomerate and increasing its cohesion. The organic binders include glucose, gums, adhesives, bitumens, waxes, starch and, preferably, lignin, in a liquid form and in particular in dilute aqueous solution.

EP-A-201 199 recommends combining the pulverulent used material with water, carrying out the granulation and covering the granules with an inert inorganic powder. From 5 to 50% by weight of water (with respect to the used material+water mixture) are employed, in order to convert the silicon to silicon dioxide (which makes it possible to deactivate the silicon).

The processes of the prior art are thus targeted, above all, at the deactivation without truly being concerned with recovery. They result in products comprising water contents which are not very compatible with their transportation, their handling and their recovery, for example in the metallurgical industries.

An object of the present invention is thus to provide a novel process for the treatment of used materials and/or fines resulting from the direct synthesis which makes possible efficient deactivation of these used materials and/or of these fines and the achievement of a stable solid product which can be transported and handled and which can in particular be directly subjected to recovery operations, in particular recovery of metals, such as silicon and copper, by the metallurgical industry.

Another object of the invention is to provide such a process which can be carried out at the lowest cost and in particular with a minimum number of stages.

A subject-matter of the present invention is thus a process for agglomerating the pulverulent used material and/or the pulverulent fines resulting from the production of organohalosilanes, comprising:
(i) the mixing of this used material and/or fines with a binder chosen from polysaccharides;
(ii) the addition to this mixture of an amount of water ranging from 3 to 10%, preferably from 4 to 8%, by weight, with respect to the used material and/or fines+binder combination;
(iii) the stirring of the solid mixture obtained in (ii), in order to obtain a homogeneous mixture; and
(iv) the production of a solid agglomerated product by compression in a press.

This process makes possible, with a reduced addition of water, the production of a nonpulverulent product existing in the form of solid, hard and rigid agglomerates of defined shape.

The expressions “used material” and “residual fines” have the usual meanings. It may be specified that they are used substances and fines resulting from the direct synthesis, thus comprising essentially silicon metal and possibly silicon oxides and small amounts of other materials, such as chlorine, hydrogen, oxygen, copper, carbon, iron, aluminum, zinc, calcium, tin, titanium, manganese, and the like.

Mention may be made, among the preferred polysaccharides, of starches and dextrins, the preference going to starches and in particular to wheat starch or to maize starch. The use of mixtures of different polysaccharides, starches and/or dextrins, for example mixtures of wheat and maize starches, also comes within the scope of the invention.

The binder/used material ratio can range in particular from 0.1/1 to 0.5/1 and is preferably between 0.15/1 and 0.3/1 by weight. It should be pointed out that, throughout the description and claims and unless otherwise mentioned, the limits are included when ranges of values are concerned.

The press advantageously exhibits means intended to confer a definite shape on the agglomerated product, by compression molding. Use may be made of any type of compression press (of the type used for the molding or the agglomeration by compression in a form, cavity or mold), such as a ram press and a roll type briquette machine. The presses used thus comprise cavities, forms or molds in which the product is agglomerated by compression and which confer, on the agglomerated product, its final shape.

In the present invention, preference will be given to cake, briquette or pellet forms with simple circular or semicircular, cylindrical or semicylindrical, or the like, geometric shapes.

Roll type briquette machines constitute a preferred embodiment. They comprise two rolls placed facing one another (parallel axes), at least one of which is arranged so as to be able to be driven in rotation and at least one of which comprises cavities of a defined shape. Generally, both rolls can be driven in rotation and in particular in opposite directions. A pressure can be exerted in an adjustable fashion between the two rolls. One of the rolls can be fixed in position on its axis and the other roll can be pressed against the preceding one using appropriate means, in particular by hydraulic means, such as pistons or jacks. It is also possible for both rolls to be movable the one toward the other in order to provide the desired pressure, for example by the use of hydraulic means as already mentioned. The roll type briquette machine thus applies a pressure, preferably an adjustable pressure, to the material which passes between the rolls, which material is molded in the cavities of defined shape which are provided at the surface of at least one of these rolls. Preferably, both rolls exhibit cavities with complementary shapes. Any desired shape can be given to the final molded-pressed material by choosing the shape of the cavities exhibited by the roll or rolls.

In order to obtain good agglomeration, it is possible to adjust the pressure applied in the press. Typically, for a roll type briquette machine, the pressure can be adjusted to between 10 and 80 kN/cm of roll width.

The passage through the mixer and through the press is accompanied by a rise in temperature, which is advantageously maintained, if necessary, between 40 and 100° C., preferably between 45 and 70° C.

By way of illustration, agglomerates having a unit volume which can vary between 0.5 and 20 cm³ can be produced. It goes without saying that these values are given solely by way of illustration.

Roll type briquette machines are designed and manufactured by companies such as Sahut-Conreur in Raismes France, and K.R. Komarek Inc. in Elk Grove Village, Ill., USA.

Stages (i), (ii) and (iii) are preferably carried out in the same mixer or homogenizer. It can be any type of solid mixer. The duration of mixing in stages (i) and (ii) can be of the order of a few minutes. In stage (ii), the addition of water can be carried out in any way known per se, for example by simply running in or else by sprinkling or spraying over the mixture from stage (i). The homogenization takes place readily despite the reduced amount of water introduced.

The roll type briquette machines are generally fed via a feed device intended to force the material between the rolls. It can in particular be a screw device or similar device, e.g. positioned vertically above the facing surfaces of the two rolls. According to an optional characteristic, the mixture resulting from the mixer passes through this feed device and then through the press.

The agglomerates obtained according to the process of the invention are not self heating or reactive with water. They can thus be handled and transported without specific measures dictated by official regulations being required.

These agglomerates can also be used as starting material for the purpose of the recovery of the silicon metal and of other metals, such as copper. They can be used in particular in businesses such as the silicon metallurgical industry, the copper metallurgical industry, the iron metallurgical industry and casting. The agglomerates can also be used in the manufacture of ceramics, refractory compounds, and the like.

The solid agglomerated products obtained or capable of being obtained by the implementation of the process according to the invention are also subject-matters of the present invention.

Another subject-matter of the present invention is an agglomerated product comprising used material and/or fines resulting from the direct synthesis, a binder chosen from polysaccharides, according to a binder/used material ratio of between 0.1/1 and 0.5/1, preferably between 0.15/1 and 0.3/1, by weight, and from 3 to 10%, preferably from 4 to 8%, of water, by weight, with respect to the used material+binder combination. This agglomerate exists in the form of a solid and rigid product, for example a molded product, for example in the form of cakes, briquettes or pellets with simple circular or semicircular, cylindrical or semicylindrical, or the like, geometric shapes, e.g. with a unit volume between 0.5 and 20 cm³. It is in particular an agglomerated product as obtained by the implementation of the process according to the invention.

In this agglomerate, the binder can more particularly be a starch and/or a dextrin, preferably starch, and in particular wheat starch and/or maize starch.

The present invention will now be described with the help of examples describing embodiments of the invention taken as nonlimiting examples.

### EXAMPLE 1

3000 grams of powdered used materials and 1290 grams of powdered wheat starch, i.e. 43% of the weight of used material, are charged to and mixed for a few minutes in a solid mixer-homogenizer (device such as Lodige horizontal mixer or mixer with planetary rotating blades). 180 grams of water, i.e. 6% of the weight of used material, are subsequently added and mixing is carried out for 5 minutes. Finally, the homogenized solid mixture is introduced into a roll type briquette machine fed via a screw feeding device.
Rotational speed of the screw feeding device: 18 revolutions/minute.
Characteristics of the roll type briquette machine (Sahut Conreur type D150):
Gap: 7/10 mm
Volume of the indentations: 0.7 cm³
Rotational speed of the rolls: 5 revolutions/minute.

The agglomerates obtained are measured as non-self-heating in the Bowes-Cameron test (sample subjected to a chamber temperature of 140° C. for 24 hours, according to the Recommendations on the Transport of Dangerous Goods, Manual of Tests and Criteria, revised third edition, United Nations, New York and Geneva, 1999) and do not react on contact with water.

EXAMPLE 2

Under the same operating conditions as for Example 1, per 3000 grams of used materials, 600 grams of powdered wheat starch, i.e. 20% of the weight of used material, and 180 grams of water, i.e. 6% of the weight of used material, are charged.

The agglomerates obtained are measured as non-self-heating in the Bowes-Cameron test (sample subjected to a chamber temperature of 140° C. for 24 hours) and do not react on contact with water.

### COMPARATIVE EXAMPLE 3

Under the same operating conditions as for Example 1, per 3000 grams of used materials, 600 grams of powdered wheat starch, i.e. 20%. of the weight of used material, are charged. The operation is carried out as above but without water.
Result: lack of agglomeration and self-heating nature.

### COMPARATIVE EXAMPLE 4

Under the same operating conditions as for Example 1, per 3000 grams of used materials, 600 grams of powdered wheat starch, i.e. 20% of the weight of used material, and 750 grams of water, i.e. 25% of the weight of used material, are charged.
Result: sticky agglomerated product which does not separate from the mold, adhesion to the rolls of the press, measurement of the self-heating nature impossible.

It should be clearly understood that the invention defined by the appended claims is not limited to the specific embodiments indicated in the above description but encompasses the alternative forms thereof which depart neither from the scope nor from the spirit of the present invention.

What is claimed is:

1. A process for agglomerating the pulverulent used material and/or the pulverulent fines resulting from the production of organohalosilanes, comprising:
(i) the mixing of this used material and/or fines with a binder chosen from polysaccharides;
(ii) the addition to this mixture of an amount of water ranging from 3 to 10%, preferably from 4 to 8%, by weight, with respect to the used material+binder combination;
(iii) the stirring of the solid mixture obtained in (ii), in order to obtain a homogeneous mixture; and
(iv) the production of a solid agglomerated product by compression in a press.

2. The process as claimed in claim 1, characterized in that the polysaccharide is a starch or a dextrin, preferably wheat starch or maize starch.

3. The process as claimed in claim 1 or 2, characterized in that the binder/used material ratio ranges from 0.1/1 to 0.5/1, preferably from 0.15/1 to 0.3/1, by weight.

4. The process as claimed in any one of claims 1 to 3, characterized in that stage (iii) is carried out using a press equipped with means for molding by compression, preferably a roll type briquette machine.

5. The process as claimed in any one of claims 1 to 4, characterized in that the temperature in stage (iv) reaches a value of between 50 and 100° C., preferably between 45 and 70° C.

6. A solid agglomerated product capable of being obtained by the implementation of the process as claimed in any one of claims 1 to 5.

7. A solid agglomerated product comprising used material and/or residual fines resulting from direct synthesis, a binder chosen from polysaccharides, according to a binder/used material ratio of between 0.1/1 and 0.5/1, preferably between 0.15/1 and 0.3/1, by weight, and from 3 to 10%, preferably from 4 to 8%, of water, by weight, with respect to the used material+binder combination.

8. The product as claimed in claim 7, characterized in that it comprises starch, preferably wheat starch and/or maize starch.

9. The product as claimed in claim 7 or 8, characterized in that it exists in the form of an agglomerated molded product preferably having a unit volume of between 0.5 and 20 cm³.
